(19) United States
(12) Patent Application Publication
(10) Pub. No.: US 2015/0256223 A1
(43) Pub. Date: Sep. 10, 2015

(54) SYSTEM AND METHOD FOR COUPLING PROXIMITY IC CARD/MODULE TO PROXIMITY COUPLING DEVICE IN LOW MUTUAL MAGNETIC COUPLING CONDITIONS

(71) Applicant: ON TRACK INNOVATIONS LTD., Rosh Pina (IL)

(72) Inventor: Nehemya Itay, Beit Hillel (IL)

(21) Appl. No.: 14/431,122

(22) PCT Filed: Sep. 17, 2013
(86) PCT No.: PCT/IL2013/050790

§ 371 Date: Mar. 25, 2015

Related U.S. Application Data
(60) Provisional application No. 61/705,328, filed on Sep. 25, 2012.

(51) Int. Cl. H04B 5/00; H04W 4/00

(52) U.S. Cl. CPC H04B 5/0031; H04W 4/008; H04B 5/0093

(57) ABSTRACT

A proximity integrated circuit card (PICC) is disclosed comprising a main loop antenna to transmit data from said PICC and a secondary loop antenna to receive RF transmission to said PICC. The main antenna and the secondary antenna arranged to yield low mutual magnetic coupling so that the RF transmission to the PICC yields bigger signal in the secondary antenna than the signal that yields in the secondary antenna from a transmission from the main antenna. According to some embodiments the secondary antenna is arranged to only partially overlap said main antenna.

### BACKGROUND OF THE INVENTION

Proximity Integrated Circuit Card (PICC) is widely used for communicating information to/from respective card reader devices in variety of applications. Proper operation of PICC devices with a respective card reader depends highly on the level of mutual magnetic coupling that is established between the card and the reader. This level is first of all dictated by geometrical aspects (relative sizes, distance and orientation between the antennas of the PICC and the reader) and secondly by the usually adverse effects of conductive (or semi conductive) objects which are present in the close vicinity of the two antennas. The induced circulating current in such objects both absorb part of the magnetic field energy and distort the three dimensional shape of the magnetic field, with the effect of reducing the level of the mutual magnetic coupling. Additional similar adverse effect is associated with the presence of materials which absorb the reader magnetic field due to its high “imaginary” permeability at the reader carrier frequency. The worst case effect is when such objects are present between the PICC and reader antennas.

In some embodiments, especially when the PICC is placed inside mobile/cellular/smartphone device, there is a need to position the PICC so that between it and a card reader there are conductive-absorbing materials such as metal cover, battery, etc. The establishment of a communication channel between the PICC and the card reader, herein after coupling, typically requires first that the PICC will receive enough RF energy from the card reader to enable proper operation of the PICC and second that for the data communication back from the PICC to the card reader, the PICC is able to produce strong enough response signal so as to enable the card reader to identify the signal and decode its data content. The PICC response to the card reader is affected by means of load modulation. The PICC changes-modulates the loading condition of its antenna, which is picked up by the card reader by means of the mutual coupling between the two antennas. When the PICC antenna is located so that such conductive and/or absorbing objects are placed between it and the card reader, the change in load may be too small to be noticed by the card reader. This adverse effect becomes the major issue if the PICC power supply issue is resolved by alternative means (e.g. power supply from its host mobile/cellular/smartphone device). The reduced magnetic coupling usually is not considered critical for the data transmission from the card reader to the PICC due to the much higher level of this signal compared with the load modulation signal back from the PICC to the card reader.

Reference is made to FIG. 1 schematically presents a PICC 20 located within a host device 10, such as mobile/cellular/smartphone device. PICC 20 may be located so that between it and the closest wall of device 10 are located conductive and/or absorbing elements, such as battery 14 and metallic outer wall 12. Coupling of PICC 14 with card reader 50 involves transmission of RF signal 52 from card reader 50 to PICC 20 and transmission of RF signal 54 from PICC 20 to card reader 50.

There is a need to enable the PICC to affect strong enough data signal to the card reader to overcome the low mutual magnetic coupling. That need cannot be fulfilled by means of the standard load modulation as the signal received card reader 50 is too low in such cases.

### SUMMARY OF THE INVENTION

A proximity integrated circuit card (PICC) comprising a main loop antenna to transmit data from said PICC and a secondary loop antenna to receive RF transmission to said PICC, said main antenna and said secondary antenna arranged to yield low mutual magnetic coupling so that said RF transmission to said PICC yields bigger signal in said secondary antenna than the signal yields in said secondary antenna from a transmission from said main antenna. According to some embodiments secondary antenna is arranged to only partially overlaps said main antenna.

A proximity integrated circuit card (PICC) comprising a main antenna to transmit data from said PICC and to receive RF transmission to said PICC, wherein said main antenna is to receive said RF transmissions during times when said main antenna does not transmit, wherein at the end of a transmit period said PICC forces a decay on said main antenna for a decay period of time, and wherein said main antenna is to begin receiving of said RF transmission only after said decay period.

A method for transmitting and receiving RF transmissions in a proximity integrated circuit card (PICC) having only one transmit and receive antenna comprising transmitting RF transmission signal from said antenna for a transmit period of time, forcing decay of said RF transmission signal at the end of said transmission period for a decay period of time and receiving RF transmission signal only after the end of said decay period of time.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically presents a PICC located within a host device, such as mobile/cellular/smartphone device;

FIG. 2 schematically presents a PICC located within a host device, such as mobile/cellular/smartphone device, according to embodiments of the present invention;

FIG. 3 schematically presenting a PICC, according to embodiments of the present invention;

FIG. 3A schematically presenting decoupling arrangement of a PICC transmitting coil and PICC pickup coil according to embodiments of the present invention;

FIG. 4A schematically presents a PICC according to yet other embodiments of the present invention; and

FIG. 4B schematically presenting timing schemes and wave forms of transmitted signal and received signal from/to a PICC according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

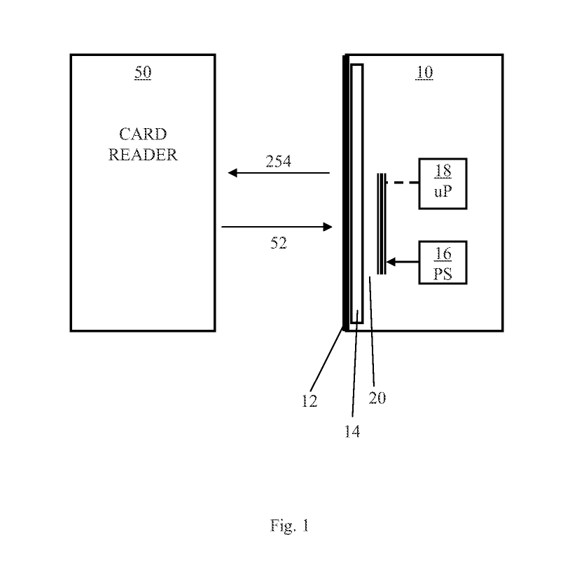

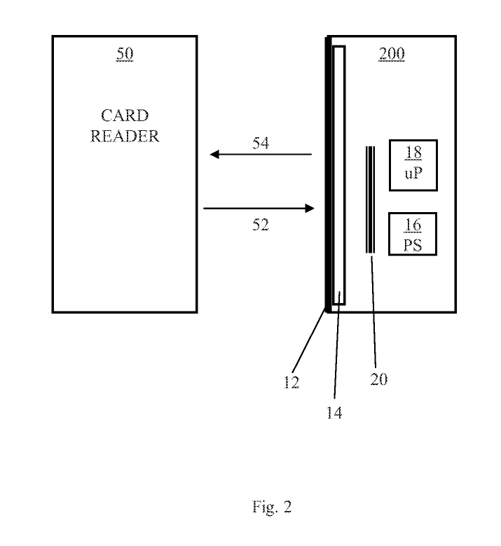

Reference is made now to FIG. 2, which schematically presents a PICC 20 located within a host device 200, such as mobile/cellular/smartphone device, according to embodiments of the present invention. PICC 20 may be located, similarly to PICC of FIG. 1, so that between it and the closest wall of device 200 are located conductive and/or absorbing elements, such as battery 14 and metallic outer wall 12. Coupling of PICC 14 with card reader 50 involves transmission of RF signal 52 from card reader 50 to PICC 20 and transmission of RF signal 254 from PICC 20 to card reader 50. Further, PICC 20 may be powered from power supply unit 16 of host device 200. Optionally, PICC 20 may be in active communication with uP 18 of host device 200, for example in order to receive data from PICC 20 and to provide data and/or control commands to PICC 20. It will be noted that PICC 20 may comprise a controller (CPU, microcontroller, etc.) inside it (not shown) as is known in the art, which is adapted to control the operation of PICC 20 according to the applicable operation scheme(s). At least two coupling difficulties may arise due to the low mutual magnetic coupling conditions in host device 200. First is low magnitude of received RF signal 52, which may bee too low to support proper operation of PICC 20. Second is low magnitude of sent signal 254 from PICC 20 to card reader 50, again, due to the low mutual magnetic coupling conditions in host device 200. As a result signal 254 may be too low to enable proper coupling, for example, in load modulation coupling mode. According to embodiments of the present invention instead of powering PICC 20 by RF signal 52 transmitted by card reader 50 PICC 20 in host device 200 may be powered by power supply unit 16, thus overcoming the too low received RF power of signal 254 through the conductive and/or absorbing medium of metallic cover 12 and battery 14.

However, powering PICC 20 from power supply unit 16 of host device 200 may not suffice, since load modulation signal picked by card reader 50 may still be too low. According to embodiments of the present invention instead of coupling PICC 20 to card reader 50 using load modulation signal, which is considered a passive approach, PICC 20 may be adapted to transmit active signal which is synchronized with card reader 50 transmitted carrier signal. According to embodiments of the present invention PICC 20 may transmit a carrier signal 254 at exactly the same frequency and with basically none changing phase difference compared with the card reader 50 transmitted carrier signal. This carrier signal is modulated by the PICC data so as to resemble, from the card reader point of view, the load modulation signal of standard PICCs. To that effect it may be modulated by the standard 848 KHz subcarrier . The sub carrier modulated signal may carry (be modulated by) the same data commonly transmitted by PICC 20 for example using load modulation coupling mode.

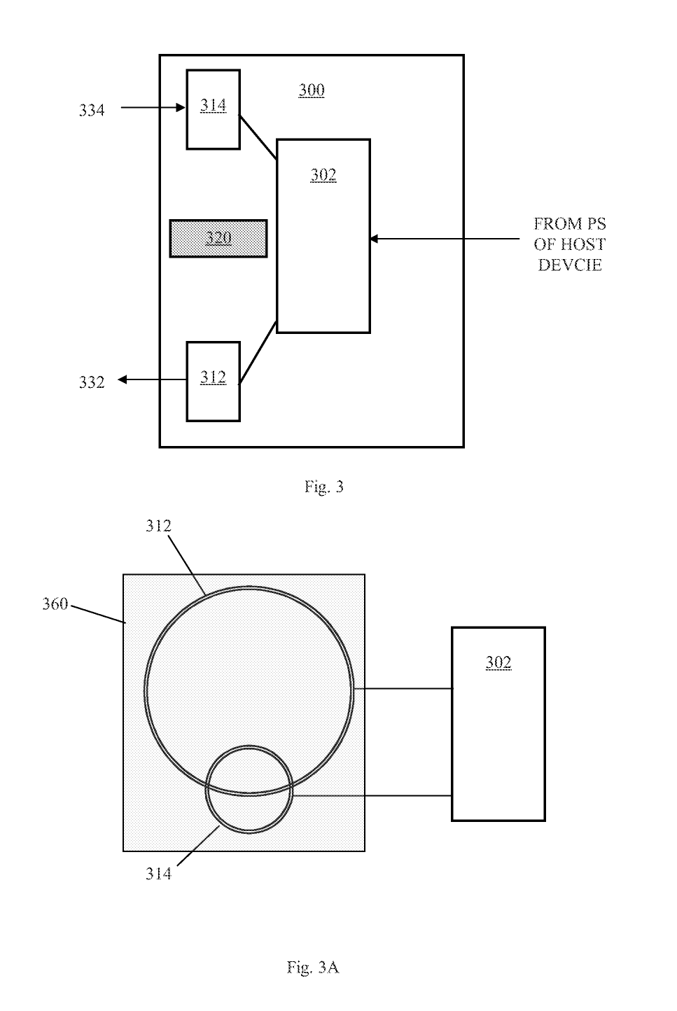

In order for the card reader to pick up the active PICC transmission signal 254 in the same manner as standard load modulation that PICC signal 254 need to be at exact same frequency of the card reader transmitted signal 52. Even the phase difference between the two signals (52 and 254) has to stay constant (within certain limits) for the whole duration of the PICC message, to refrain from corrupting the PICC transmitted data, decoded by the card reader. Such precise synchronization requires the PICC to pick up the card reader signal as reference at least during certain periods inside the PICC message period. According to one embodiment of the present invention the PICC may be equipped with two coils. Reference is made now to FIG. 3, schematically presenting PICC 300, according to embodiments of the present invention. PICC 300 may comprise at least card controller 302 in active communication with transmit antenna coil 312 adapted to transmit signals from PICC 300 to a card reader (not shown) and receive antenna coil 314 (also called pickup coil) adapted to receive transmission signal 334 from the card reader. An RF isolation arrangement 320 may be provided to magnetically decouple coils 312 and 314 from one another in order to enable coil 314 to receive transmissions signals from the card reader (in order to provide synch timing) concurrently with the transmissions of coil 312, without interfering with each other. Such isolation arrangement typically involves the use of ferrite materials. The ability to perform the required “listen-while-talk” function depends highly on the magnetic decoupling provided by isolator element 320.

Reference is made now to FIG. 3A, schematically presenting decoupling arrangement of transmitting coil 312 and pickup coil 314, according to embodiments of the present invention. Pickup coil 314 may be placed over transmitting coil 312, partly inside of it and partly outside. Both geometries should be fine tuned to achieve maximum cancelation of the mutual coupling. One main problem in using this solution may be the effect of the metallic environments included in at least some of the host devices models, which may differ from one host device model to another, on the mutual coupling and the fine tuning mentioned above should consider this effect. Ferrite layer and/or well-placed metallic layer(s) 360 may reduce the effect inflicted by the various metallic environments of various host devices on the mutual coupling. In addition a special circuitry may be designed to inject a controlled and calibrated amount of PICC carrier into the pickup circuitry of coil 314 in anti phase to the coupled transmission phase in coil 312 so as to further reduce this coupling. The amount of injected signal may be calibrated while running PICC 300 without the presence of an active card reader so as to make sure the cancelation adjustment does not cancels the card reader signal.

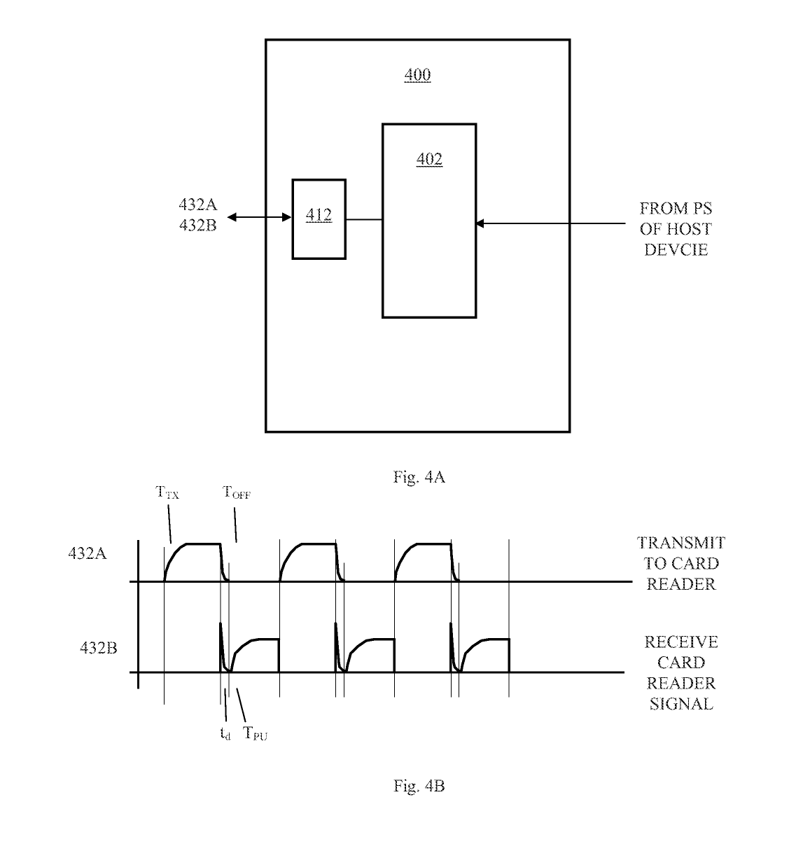

According to another embodiment of the present invention a PICC may perform active synchronization using only a single transmit/receive coil. Reference is made now to FIG. 4A, schematically presenting PICC 400 according to embodiments of the present invention and to FIG. 4B, schematically presenting timing schemes and wave forms of an envelope of transmitted signal 432A and an envelope of received signal 432B from/to PICC 400, according to embodiments of the present invention. PICC 400 may comprise at least controller unit 402 powered, for example, from power supply unit of the host device and in active communication with transmit/receive antenna coil 412. Coil 412 may be controlled to switch from receive to transmit and vise versa by controller unit 402.

The transmitted signal 432A from PICC 400 to a card reader is expected to be much larger than the picked-up signal 432B received by PICC 400 from the card reader. Therefore, a forced very fast decay of the transmitted signal may be activated for short time t_{d} at the beginning of each off period T_{OFF}. Such forced decay may be realized for example by shorting the antenna upon deactivation of the transmitter, allowing the coil stored energy to dissipate in the shorting switch. This may be embodied, for example, utilizing an FET transistor as shortening means. Following the completion of the shorting action the short should be removed to allow the signal from the card reader to develop in antenna coil 412 to a sufficient level by the end of the off period, in order to ensure steady and accurate synch signal. During this pick up time T_{PU} a suitable Q should be enforced over antenna coil 412 to optimize the signal rise time and final level, taking into consideration the length of the “Off” period. For Type A format a higher Q can be used as the Off period is relatively long. Type A OOK Manchester coding provides half byte off period duration, 64 carrier cycles, which is about 4.7 us at 107 Kbps (less for higher data rates). For Type B a much lower Q must be kept due to the very short off duration. Continuous subcarrier modulation leaves only half subcarrier period. For Type B 8 carrier cycles is about 590 ns, much shorter compared with Type A. The Q factor can be adjusted for example by connecting suitable resistor in parallel to the coil (utilizing a FET switch) (not shown). A special “gated” phased-lock loop (PLL) may be required to re-synch only during each “Off” period.

By the end of the “Off” period, when transmission from PICC 400 is resumed, the coil's Q factor may be optimized to fit the on period which is 8 carrier cycles so this Q factor can't be too high.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A proximity integrated circuit card (PICC) comprising:
a main loop antenna configured to transmit an outgoing radio frequency (RF) transmission from said PICC;
a secondary loop antenna configured to receive an incoming RF transmission to said PICC;
said main loop antenna and said secondary loop antenna arranged to yield a low mutual magnetic coupling such that a first signal yielded in said secondary loop antenna from said RF incoming transmission to said PICC is larger than a second signal yielded in said secondary loop antenna from said outgoing RF transmission from said main loop antenna.

2. The PICC of claim 1, wherein said secondary loop antenna is arranged to partially overlap said main loop antenna.

3. The PICC of claim L wherein a magnetic isolator is arranged between said main loop antenna and said secondary loop antenna.

4. The PICC of claim 3, wherein said magnetic isolator is at least partially composed of ferrite.

5. A proximity integrated circuit card (PICC) comprising:
an antenna configured to transmit outgoing radio frequency (RF) transmissions from said PICC and to receive incoming RF transmissions to said PICC;
wherein said antenna is configured to receive said incoming RF transmissions during one or more off periods of time when said antenna is not transmitting said outgoing RF transmissions,
wherein at a beginning of said one or more off periods of time said PICC is configured to force a signal decay on said outgoing RF transmissions at said antenna for a decay period of time, and
wherein said antenna is configured to begin receiving said incoming RF transmissions only after said decay period of time.

6. The PICC of claim 5 configured to force said signal decay on said outgoing RF transmission from said antenna by means of shorting of one or more terminals of said antenna.

7. A method for transmitting and receiving radio frequency (RF) transmissions in a proximity integrated circuit card (PICC) having one antenna for transmitting and receiving, the method comprising:
transmitting an outgoing RF transmission from said antenna during a transmit period of time;
forcing decay of said outgoing RF transmission during a decay period of time at the beginning of an off period of time when said antenna is not transmitting said outgoing RF transmission; and
receiving an incoming RF transmission only after the end of said decay period of time.

8. The method of claim 7, wherein said forcing is done by means of shorting of one or more terminals of said antenna.

9. The PICC of claim 1, further comprising anti-phase circuitry configured to inject an amount of said outgoing RF transmission of said main loop antenna into said secondary loop antenna in anti-phase to a mutual magnetically coupled outgoing RF transmission of said main loop antenna such that a combined outgoing RF transmission coupled to said secondary loop antenna is reduced without canceling said incoming RF transmission to the PICC.

10. A method for transmitting and receiving radio frequency (RF) transmissions in a proximity integrated circuit card (PICC) having a main loop antenna and a secondary loop antenna, the method comprising:
transmitting an outgoing RF transmission from said PICC via said main loop antenna; and
receiving an incoming RF transmission to said PICC via said secondary loop antenna;
wherein said main loop antenna and said secondary loop antenna are arranged to yield a low mutual magnetic coupling such that a first signal yielded in said secondary loop antenna from said incoming RF transmission to said PICC is larger than a second signal yielded in said secondary loop antenna from said outgoing RF transmission from said main loop antenna.

11. The method of claim 10 wherein said secondary loop antenna is arranged to partially overlap said main loop antenna.

12. The method of claim 10 wherein a magnetic isolator is arranged between said main loop antenna and said secondary loop antenna.

13. The method of claim 12 wherein said magnetic isolator is at least partially composed of ferrite.

14. The method of claim 10 further comprising:
injecting an amount of said outgoing RF transmission of said main loop antenna into said secondary loop antenna in anti-phase to a mutual magnetically coupled outgoing RF transmission of said main loop antenna such that a combined outgoing RF transmission coupled to said secondary loop antenna is reduced without canceling said incoming RF transmission to the PICC.
